(19) United States
(12) Patent Application Publication
(10) Pub. No.: US 2019/0052089 A1
(43) Pub. Date: Feb. 14, 2019

(54) POWER GENERATION SYSTEM HAVING VARIABLE SPEED ENGINE AND METHOD FOR CRANKING THE VARIABLE SPEED ENGINE

(71) Applicant: General Electric Company, Schenectady, NY (US)

(72) Inventors: Govardhan GANIREDDY, Bangalore (IN); Arvind Kumar TIWARI, Bangalore (IN); Yashomani Y KOLHATKAR, Bangalore (IN); Somakumar RAMACHANDRAPANICKER, Bangalore (IN); Rahul Radhakrishna PILLAI, Bangalore (IN)

(21) Appl. No.: 16/080,253

(22) PCT Filed: Jan. 26, 2017
(86) PCT No.: PCT/US2017/015039

§ 371 Date: Aug. 27, 2018

(30) Foreign Application Priority Data
Mar. 22, 2016 (IN) 201641009988

(51) Int. Cl. H02J 3/38; H02P 9/00; H02K 17/42; H02P 9/48; H02P 9/06

(52) U.S. Cl. CPC H02J 3/383; H02P 9/007; H02P 9/06; H02P 9/48; H02K 17/42

(57) ABSTRACT

A power generation system (101) is disclosed. The power generation system (101) includes a variable speed engine (106) and a DFIG (108) coupled thereto. The DFIG (108) includes a generator (112), a rotor side converter (114), and a line side converter (116) electrically coupled to the generator (112). The rotor side converter (114) is configured to aid in operating the generator (112) as motor to crank the variable speed engine (106). The power generation system (101) further includes a PV power source (110) and/or an energy storage device (122) electrically coupled to a DC-link (118) between the rotor side converter (114) and the line side converter (116). A method of cranking the variable speed engine is also disclosed.

### BACKGROUND

The present application relates generally to generation of electrical power and more particularly relates to a power generation system employing a variable speed engine and a photo-voltaic (PV) power source.

Typically, power generation systems such as generators use fuels such as diesel, petrol, and the like to generate an electrical power that can be supplied to local electrical loads. Reducing consumption of the fuels is an ongoing effort in achieving low cost and environment friendly power generation systems. To that end, various hybrid power generation systems are available that use a generator operated by an engine as primary source of electricity and some form of renewable energy source such as a wind turbine as an auxiliary source of electricity.

At some instances, it may be desirable to crank the engine for generating the electrical power by the generator. In currently available systems, the engine is cranked via an additional motor that may be mechanically coupled to a crank-shaft of the engine. Moreover, the currently available systems may also include an additional power source such as a battery to operate the motor. Use of such additional components like the motor and the battery occupies more space and also increases overall cost of the system.

### BRIEF DESCRIPTION

In accordance with an embodiment of the invention, a power generation system is disclosed. The power generation system includes a variable speed engine. The power generation system further includes a doubly-fed induction generator (DFIG) mechanically coupled to the variable speed engine. The DFIG includes a generator having a rotor winding disposed on a rotor and a stator winding disposed on a stator. The DFIG further includes a rotor side converter electrically coupled to the rotor winding and configured to aid in operating the generator as motor to crank the variable speed engine. Furthermore, the DFIG includes a line side converter electrically coupled to the stator winding at a point of common coupling (PCC), wherein the rotor side converter and the line side converter are electrically coupled to each other via a direct current (DC) link. Moreover, the power generation system also includes at least one of a photo voltaic (PV) power source and an energy storage device electrically coupled to the DC-link.

In accordance with an embodiment of the invention, a method for cranking a variable speed engine mechanically coupled to a DFIG is disclosed. The method includes supplying a DC power to a DC-link of the DFIG, wherein the DFIG includes a generator including a rotor winding disposed on a rotor and a stator winding disposed on a stator, a rotor side converter electrically coupled to the rotor winding, and a line side converter electrically coupled to the stator winding at a PCC, wherein the rotor side converter and the line side converter are electrically coupled to each other via the DC-link. The method further includes cranking the variable speed engine by operating the generator as motor via the rotor side converter.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an electrical power distribution system having a variable speed engine, in accordance with aspects of the present specification; and

FIG. 2 is a flowchart of an example method for cranking a variable speed engine mechanically coupled to a doubly-fed induction generator, in accordance with aspects of the present specification.

### DETAILED DESCRIPTION

The specification may be best understood with reference to the detailed figures and description set forth herein. Various embodiments are described hereinafter with reference to the figures. However, those skilled in the art will readily appreciate that the detailed description given herein with respect to these figures is for explanatory purposes as the method and the system may extend beyond the described embodiments.

In the following specification, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

In accordance with some aspects of the present specification, a power generation system is disclosed. The power generation system includes a variable speed engine. The power generation system further includes a doubly-fed induction generator (DFIG) mechanically coupled to the variable speed engine. The DFIG includes a generator having a rotor winding disposed on a rotor and a stator winding disposed on a stator. The DFIG further includes a rotor side converter electrically coupled to the rotor winding and configured to supply an electrical power to the rotor winding such that the generator is operable as a motor to crank the variable speed engine. The term “crank” or “cranking” as used herein refers to an event of starting the variable speed engine by rotating a crank-shaft of the variable speed engine by applying a force thereto. Furthermore, the DFIG includes a line side converter electrically coupled to the stator winding at a point of common coupling (PCC), where the rotor side converter and the line side converter are electrically coupled to each other via a direct current (DC) link. Moreover, the power generation system also includes at least one of a photo voltaic (PV) power source and an energy storage device electrically coupled to the DC-link.

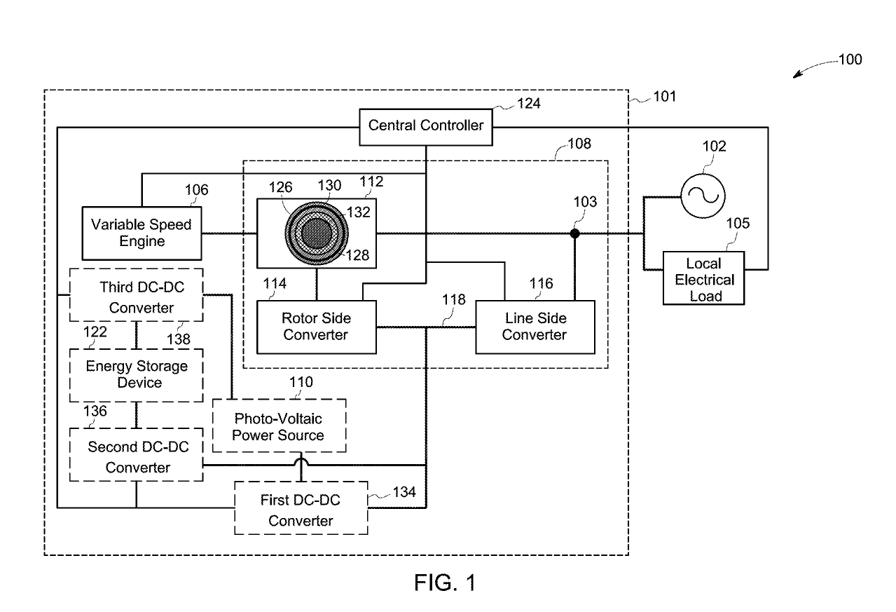

FIG. 1 is a block diagram of an electrical power distribution system 100, in accordance with aspects of the present specification. The electrical power distribution system 100 may include a power generation system 101 coupled to an electric grid 102 at a point of common coupling (PCC) 103. In some embodiments, the power generation system 101 may be coupled to the PCC 103 via a transformer (not shown in FIG. 1). In some embodiments, the PCC 103 may be coupled to a local electrical load 105 to enable supply of an AC power to the local electrical load 105.

The electric grid 102 may be representative of an interconnected network for delivering a grid power (e.g., electricity) from one or more power generation stations (different from the power generation system 101) to consumers (e.g., the local electrical load 105) through high/medium voltage transmission lines. The grid power may be received at the PCC 103 from the electric grid 102. The local electrical load 105 coupled to the PCC 103 may include electrical devices that are operable using the electric power received from the electric grid 102 or the power generation system 101.

In some embodiments, the power generation system 101 may include one or more variable speed engines such as a variable speed engine 106, a doubly-fed induction generator (DFIG) 108, and at least one of a photo-voltaic (PV) power source 110 and an energy storage device 122. In some embodiments, the power generation system 101 may also include a central controller 124 operatively coupled to at least one of the variable speed engine 106 and the DFIG 108. The central controller 124 may be configured to control the operations of the variable speed engine 106 and the DFIG 108. In some embodiments, the DFIG 108 may include one or more of a generator 112, a rotor side converter 114, and a line side converter 116.

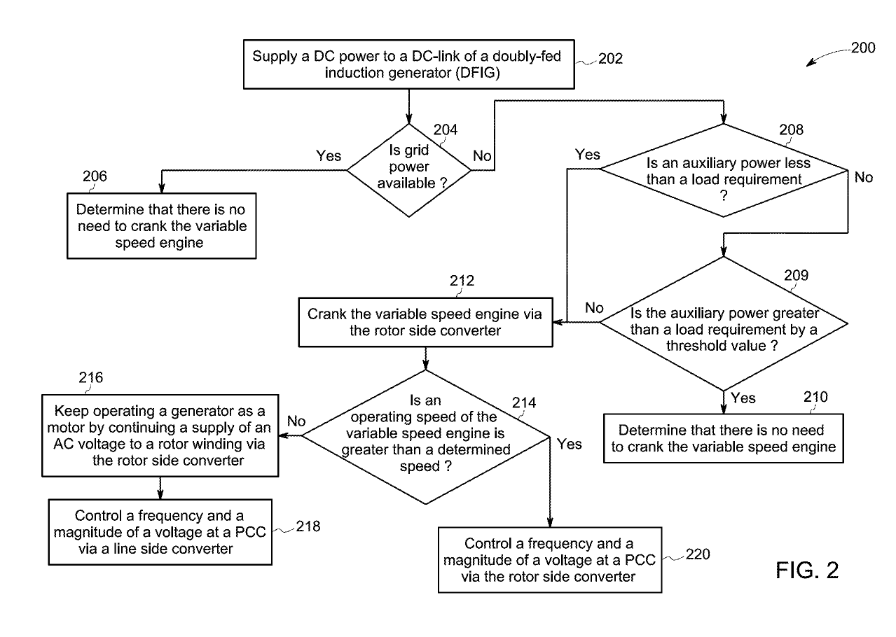

In one embodiment, the central controller 124 may include a specially programmed general purpose computer, a microprocessor, a digital signal processor, and/or a microcontroller. The central controller 124 may also include input/output ports, and a storage medium, such as, an electronic memory. Various examples of the microprocessor include, but are not limited to, a reduced instruction set computing (RISC) architecture type microprocessor or a complex instruction set computing (CISC) architecture type microprocessor. Further, the microprocessor may be a single-core type or multi-core type. Alternatively, the central controller 124 may be implemented as hardware elements such as circuit boards with processors or as software running on a processor such as a commercial, off-the-shelf personal computer (PC), or a microcontroller. In certain embodiments, the variable speed engine 106, the rotor side converter 114, and the line side converter 116 may include controllers/control units/electronics to control their respective operations under a supervisory control of the central controller 124. The central controller 124 may be capable of executing program instructions for controlling operations of the power generation system 101, the electrical devices constituting the local electrical load 105. In some embodiments, the central controller 124 may aid in executing a method for cranking the variable speed engine 106 (see FIG. 2).

The variable speed engine 106 may refer to any system that may aid in imparting a controlled rotational motion to rotary element(s) (e.g., a rotor) of the generator 112. For example, the variable speed engine 106 may be an internal combustion engine, an operating speed of which may be varied by the central controller 124. More particularly, the variable speed engine 106 may be a variable speed reciprocating engine where the reciprocating motion of a piston is translated into a rotational speed of a crank shaft connected thereto. The variable speed engine 106 may be operated by combustion of various fuels including, but not limited to, diesel, natural gas, petrol, LPG, biogas, producer gas, and the like. The variable speed engine 106 may also be operated using waste heat cycle. It is to be noted that the scope of the present specification is not limited with respect to the types of fuel and the variable speed engine 106 employed in the power generation system 101.

The DFIG 108 may include the generator 112. In a non-limiting example, the generator 112 may be a wound rotor induction generator. The generator 112 may include a stator 126, a rotor 128, a stator winding 130 disposed on the stator 126, and a rotor winding 132 disposed on the rotor 128. The generator 112 may further be electrically coupled to the PCC 103 to provide a first electrical power (voltage and current) at the PCC 103. More particularly, the stator winding 130 may be coupled (directly or indirectly) to the PCC 103.

The DFIG 108 may be mechanically coupled to the variable speed engine 106. In some embodiments, the rotor 128 of the generator 112 may be mechanically coupled to the crank shaft of the variable speed engine 106, such that, during operation, rotations of the crank shaft may cause a rotary motion of the rotor 128 of the generator 112, and vice versa. In some embodiments, the crank shaft of the variable speed engine 106 may be coupled to the rotor 128 of the generator 112 through one or more gears.

In some embodiments, the DFIG 108 may further include the rotor side converter 114 and the line side converter 116. Each of the rotor side converter 114 and the line side converter 116 may act as an AC-DC converter or a DC-AC converter, and may be controlled by the central controller 124. The rotor side converter 114 may be electrically coupled to the rotor winding 132. Further, the line side converter 116 may be electrically coupled to the stator winding 130 at the PCC 103. The line side converter 116 may further be coupled to the PCC 103, directly or via a transformer (not shown in FIG. 1). In one embodiment, the rotor side converter 114 and line side converter 116 are also coupled to each other. For example, the rotor side converter 114 and the line side converter 116 are electrically coupled to each other via a DC-link 118. In some embodiments, the rotor side converter 114 may be configured to aid in operating the generator 112 as a motor to crank the variable speed engine 106. Further details of cranking the variable speed engine 106 are described in conjunction with FIG. 2. In some embodiments, the generator 112, when operated as the motor may be configured to produce a determined amount of torque. The determined amount of torque produced by the generator 112 may be based on one or more of a DC-link voltage, a rotor side current capacity of the rotor side converter 114, and a turn's ratio of the stator winding 130 and the rotor winding 132. The term “rotor side current capacity” as used herein refers to a maximum amount of current that can be handled by the rotor side converter 114.

Further, the power generation system 101 may include at least one of the PV power source 110 and the energy storage device 122 electrically coupled to the DFIG 108 at the DC-link 118. The PV power source 110 may include one or more PV arrays (not shown in FIG. 1), where each PV array may include at least one PV module (not shown in FIG. 1). A PV module may include a suitable arrangement of a plurality of PV cells (diodes and/or transistors). The PV power source 110 may generate a DC voltage constituting a second electrical power that depends on solar insolation, weather conditions, and/or time of the day. Accordingly, the PV power source 110 may be configured to supply the second electrical power to the DC-link 118. A maximum amount of the second electrical power that can be produced by the PV power source 110 may be referred to as “PV rating.”

In some embodiments, the PV power source 110 may be electrically coupled to the DFIG 108 at the DC-link 118 via a first DC-DC converter 134. The first DC-DC converter 134 may be electrically coupled between the PV power source 110 and the DC-link 118. In such an instance, the second electrical power may be supplied from the PV power source 110 to the DC-link 118 via the first DC-DC converter 134. The first DC-DC converter 134 may be operated as a buck converter, a boost converter, or a buck-boost converter and may be controlled by the central controller 124.

The energy storage device 122 may include arrangements employing one or more batteries, capacitors, and the like. In some embodiments, the energy storage device 122 may be electrically coupled to the DFIG 108 at the DC-link 118 to supply a third electrical power to the DC-link 118. A maximum amount of the third electrical power the can be supplied by the energy storage device 122 may be referred to as “energy storage device rating.”

In some embodiments, the energy storage device 122 may be electrically coupled to the DFIG 108 at the DC-link 118 via a second DC-DC converter 136. The second DC-DC converter 136 may be electrically coupled between the energy storage device 122 and the DC-link 118. In such an instance, the third electrical power may be supplied from the energy storage device 122 to the DC-link 118 via the second DC-DC converter 136. The second DC-DC converter 136 may be operated as a buck converter, a boost converter, or a buck-boost converter and may be controlled by of the central controller 124.

In some embodiments, the power generation system 101 may also include a third DC-DC converter 138. The third DC-DC converter 138 may be electrically coupled between the energy storage device 122 and the PV power source 110. In some embodiments, the third DC-DC converter 138 may be configured to charge the energy storage device 122 via the PV power source 110. For example, in some embodiments, the energy storage device 122 may receive a charging current via the third DC-DC converter 138 from the PV power source 110. The third DC-DC converter 138 may be operated as a buck converter, a boost converter, or a buck-boost converter and may be controlled by the central controller 124.

In some embodiments, in addition to being operatively coupled to the variable speed engine 106, the generator 112, the rotor side converter 114, the line side converter 116, and the central controller 124 may be operatively coupled (as shown using dashed connectors) to at least one of the first DC-DC converter 134, the second DC-DC converter 136, and the third DC-DC converter 138 to control their respective operations. Furthermore, in some embodiments, the central controller 124 may be operatively coupled (as shown using dashed connector) to the local electrical load 105 to selectively connect and disconnect the respective electrical device to manage load.

As previously noted, the central controller 124 may aid in executing a method for cranking the variable speed engine 106 (see FIG. 2). In some embodiments, the central controller 124 may aid in executing steps 202-220 of FIG. 2. In order to execute the steps 202-220 of FIG. 2, the central controller 124 may be configured to control the operation of one or more of the generator 112, the rotor side converter 114, the line side converter 116, the first DC-DC converter 134, and/or the second DC-DC converter 136. By way of example, the central controller 124 may configure the rotor side converter 114, the line side converter 116, the first DC-DC converter 134, and/or the second DC-DC converter 136 to allow a flow of the power therethrough in a determined direction to aid in cranking of the variable speed engine 106.

FIG. 2 is a flowchart 200 of an example method for cranking the variable speed engine 106 mechanically coupled to the DFIG 108, in accordance with aspects of the present specification. As previously noted, in the power generation system 101, the DC-link 118 may be electrically coupled to one or both of the PV power source 110 and the energy storage device 122, directly or via the first DC-DC converter 134 and, the second DC-DC converter 136, respectively.

The method, at step 202, includes supplying a DC power to the DC-link 118 of the DFIG 108. In one embodiment, the DC power to the DC-link 118 may be supplied from the PV power source 110. In some embodiments, supplying the DC power to the DC-link 118 may include supplying at least one of the second electric power from the PV power source 110 or a third electric power from the energy storage device 122. For example, the second electrical power generated by the PV power source 110 may be supplied to the DC-link 118. In some embodiments, the second electrical power generated by the PV power source 110 may be supplied to the DC-link 118 via the first DC-DC converter 134. In another embodiment, the DC power to the DC-link 118 may be supplied from the energy storage device 122. For example, the third electrical power from the energy storage device 122 may be supplied to the DC-link 118. In some embodiments, the third electrical power may be supplied to the DC-link 118 via the second DC-DC converter 136. In yet another embodiment, both the second electrical power and the third electrical power may be supplied to the DC-link 118.

At step 204, the central controller 124 may be configured to determine whether the grid power is available or not. In some embodiments, the power generation system 101 may include one or more sensors (voltage sensors and/or current sensors, not shown in FIG. 1) disposed at the PCC 103. The one or more sensors may sense the voltage and/or current being supplied at the PCC 103 from the electric grid 102. The one or more sensors may further be configured communicate the sensed an information about the sensed voltage and/or current to the central controller 124.

At step 204, if it is determined that the grid power is available, the central controller 124, at step 206, may determine that there is no need to crank the variable speed engine 106. In such situation when the grid power is available, the grid power may be supplied to the local electrical load 105 via the PCC 103. However, at step 204, if it is determined that the grid power is not available, the central controller 124, at step 208, may further be configured to determine whether an auxiliary power is less than a load requirement. In some embodiments, the auxiliary power may include the second electrical power when only the PV power source 110 is coupled the DC-link 118. In some embodiments, the auxiliary power may include the third electrical power if only the energy storage device 122 is coupled the DC-link 118. In some embodiments, the auxiliary power may include a sum of the second electrical power and the third electrical power if both the PV power source 110 and the energy storage device 122 are coupled the DC-link 118.

At step 208, if it is determined that the auxiliary power is greater than the load requirement, at step 209, (optionally or additionally) another check may be carried out by the central controller 124 to determine whether the auxiliary power is greater than the load requirement by a threshold value. In some embodiments, it may be advantageous to have such provisions to at least partly compensate for any unpredicted variations in the auxiliary power. At step 209, if it is determined that the auxiliary power is greater than the load requirement by the threshold value, the central controller 124, at step 210 may determine that there is no need to crank the variable speed engine 106. Accordingly, the power that may be supplied to the local electrical load 105 may be based on the auxiliary power. However, alternatively, at step 209, if it is determined that the auxiliary power is not greater than the load requirement by the threshold value, the variable speed engine 106 may be cranked via the rotor side converter 114, at step 212, by operating the generator 112 as motor. Referring back to step 208, if it is determined that the auxiliary power is less than the load requirement; the variable speed engine 106 may be cranked via the rotor side converter 114, at step 212, by operating the generator 112 as motor.

In some embodiments, the variable speed engine 106 may be cranked by controlling at least one of a voltage or a current applied to the rotor winding 132 via the rotor side converter 114 such that the generator 112 may be operable as motor. For example, the rotor side converter 114 may be operated as a DC-AC converter to supply an AC voltage to the rotor winding 132, where the AC voltage is obtained from a DC-voltage available at the DC-link 118. In some embodiments, the rotor side converter 114 may be configured to control at least one of a frequency and a magnitude of the AC voltage being applied to the rotor winding 132 to crank the variable speed engine 106.

In some embodiments, while controlling at least one of the voltage or the current applied to the rotor winding 132, the stator winding 130 may be disconnected from the local electrical load 105. Additionally or alternatively, in some embodiments, the stator winding 130 may be shorted while controlling at least one of the voltage or the current applied to the rotor winding 132. The stator winding 130 may be sorted via some electrical connector or by appropriately controlling switches within the line side converter 116.

In some embodiments, cranking the variable speed engine includes shorting the rotor winding 132 via the rotor side converter 114. The rotor winding 132 may be shorted by appropriately controlling switches within the rotor side converter 114. In some embodiments, while the rotor winding 132 is shorted via the rotor side converter 114, a voltage and/or a current may be supplied to the stator winding 130 from the PCC 103 such that the generator 112 may be operable as motor.

In some embodiments, at step 212, while the rotor side converter 114 may be configured to crank the variable speed engine 106, the line side converter 116 may be configured to control a frequency and a magnitude of a voltage at the PCC 103. In some embodiments, the central controller 124 may be configured to operate the line side converter 116 as DC-AC converter to control the frequency and the magnitude of a voltage at the PCC 103. In some embodiments, the line side converter 116 may convert the DC voltage from the DC-link 118 into an AC voltage, which is supplied to the PCC 103. In a non-limiting example, the line side converter 116 may be configured to maintain the frequency and the magnitude of the AC voltage at the PCC 103 substantially close to the frequency (i.e., rated frequency) and the magnitude of the voltage of the grid power.

In some embodiments, the rotor side converter 114 may be configured to supply the AC voltage to the rotor winding 132 until the speed of the variable speed engine reaches a determined speed. In some embodiments, at step 214, the central controller 124 may be configured to determine whether the operating speed of the variable speed engine is greater than the determined speed. In order to determine whether the operating speed of the variable speed engine is greater than the determined speed, the central controller 124 may be configured to compare a current operating speed of the variable speed engine with the determined speed. At step 214, if it is determined that the current operating speed of the variable speed engine 106 is less than the determined speed, the central controller 124, at step 216, may be configured to continue operation of the generator 112 as a motor by continuing the supply of the AC voltage to the rotor winding 132 via the rotor side converter 114.

In addition, at step 214, if it is determined that the current operating speed of the variable speed engine 106 is less than the determined speed, the central controller 124, at step 218, may further be configured to control a frequency and a magnitude of a voltage at the PCC 103 via the line side converter 116. In some embodiments, the central controller 124 may be configured to operate the line side converter 116 as DC-AC converter to control the frequency and the magnitude of a voltage at the PCC 103. In some embodiments, the line side converter 116 may convert the DC voltage from the DC-link 118 into an AC voltage, which is supplied to the PCC 103. In a non-limiting example, the line side converter 116 may be configured to maintain the frequency and the magnitude of the AC voltage at the PCC 103 substantially close to the frequency (i.e., rated frequency) and the magnitude of the voltage of the grid power.

However, at step 214, if it is determined that the current operating speed of the variable speed engine 106 is greater than the determined speed, the central controller 124, at step 220, may be configured to control the frequency and the magnitude of the voltage at the PCC 103 via the rotor side converter 114. In some embodiments, the central controller 124 may be configured to operate the rotor side converter 114 as a DC-AC converter to provide electrical excitation to the rotor winding 132. It is to be noted that, when cranked, the variable speed engine 106 may be capable of operating based on combustion of fuel(s) causing generation of a first electrical power at the stator winding 130. The first electrical power may be supplied to the PCC 103. The magnitude and frequency of the voltage (e.g., the first electrical power) may be controlled, at least in part, via the electrical excitation being supplied to the rotor winding 132 from the rotor side converter 114.

Typically, a slip of the generator 112 may be defined as represented by Equation (1):

$$S = \frac{{N}_{s} - {N}_{r}}{{N}_{s}} \qquad Equation ( 1 )$$

where, Nᵣ represents operating speed of the rotor 128 in revolution per minute (rpm) and Nₛ represents a synchronous speed of the generator 112. Further, Nₛ is represented by Equation (2):

$${N}_{s} = \frac{120 f}{p} \qquad Equation ( 2 )$$

where, f represents frequency of current flowing through the stator winding 130, and p represents number of stator poles.

The generator 112 may operate in different modes depending on the operating speed (rpm) of the rotor 128. For example, the generator 112 may operate in sub-synchronous mode if Nᵣ is lower than Nₛ. Alternatively, the generator 112 may operate in synchronous mode if Nᵣ is same as Nₛ. Further, the generator 112 may operate in super-synchronous mode if Nᵣ is greater than Nₛ. In some embodiments, when the generator 112 operates in super-synchronous mode, the generator 112 may be configured to generate additional electrical power (hereinafter referred to as a fourth electrical power) at the rotor winding 132.

Furthermore, as the electrical power (i.e., the voltage and/or current) to crank the variable speed engine 106 is supplied to the generator 112 via the rotor side converter 114, it may be desirable to appropriately select a power rating of the rotor side converter 114. In some embodiments, the power rating of the rotor side converter 114 may be selected based on a maximum slip range or an instantaneous slip of the DFIG 108.

Any of the foregoing steps and/or system elements may be suitably replaced, reordered, or removed, and additional steps and/or system elements may be inserted, depending on the needs of a particular application, and that the systems of the foregoing embodiments may be implemented using a wide variety of suitable processes and system elements and are not limited to any particular computer hardware, software, middleware, firmware, microcode, etc.

Furthermore, the foregoing examples, demonstrations, and method steps such as those that may be performed by the central controller 124 may be implemented by suitable code on a processor-based system, such as a general-purpose or special-purpose computer. Different implementations of the systems and methods may perform some or all of the steps described herein in different orders, parallel, or substantially concurrently. Furthermore, the functions may be implemented in a variety of programming languages, including but not limited to C++ or Java. Such code may be stored or adapted for storage on one or more tangible or non-transitory computer readable media, such as on data repository chips, local or remote hard disks, optical disks (that is, CDs or DVDs), memory or other media, which may be accessed by a processor-based system to execute the stored code. Note that the tangible media may include paper or another suitable medium upon which the instructions are printed. For instance, the instructions may be electronically captured via optical scanning of the paper or other medium, then compiled, interpreted or otherwise processed in a suitable manner if necessary, and then stored in the data repository or memory.

In accordance with some embodiments of the invention, the power generation system may be operated at higher efficiencies by ensuring that converters (the rotor side converter and the line side converter) and the variable speed engine are operated at the best efficiency for a given load requirement. Moreover, wear and tear of the variable speed engine may also be reduced, since lower speed of operation increases the life of internal mechanical components of the variable speed engine. Moreover, the PV power source may be utilized as primary power source leading to more environmental friendly and cost effective power generation system. Also, overall fuel consumption by the variable speed engine may be reduced as the PV power source may be utilized as primary power source. Additionally, as the DC local electrical load is coupled at the DC-link, use of additional converters may be greatly avoided or minimized, resulting in additional cost savings.

The present invention has been described in terms of some specific embodiments. They are intended for illustration only, and should not be construed as being limiting in any way. Thus, it should be understood that modifications can be made thereto, which are within the scope of the invention and the appended claims.

It will be appreciated that variants of the above disclosed and other features and functions, or alternatives thereof, may be combined to create many other different systems or applications. Various unanticipated alternatives, modifications, variations, or improvements therein may be subsequently made by those skilled in the art and are also intended to be encompassed by the following claims.

1. A power generation system, comprising:
a variable speed engine;
a doubly-fed induction generator (DFIG) mechanically coupled to the variable speed engine, wherein the DFIG comprises:
a generator comprising a rotor winding disposed on a rotor and a stator winding disposed on a stator;
a rotor side converter electrically coupled to the rotor winding and configured to aid in operating the generator as a motor to crank the variable speed engine; and
a line side converter electrically coupled to the stator winding at a point of common coupling (PCC), wherein the rotor side converter and the line side converter are electrically coupled to each other via a direct current (DC) link; and
at least one of a photo-voltaic (PV) power source and an energy storage device electrically coupled to the DC-link.

2. The power generation system of claim 1, wherein when the variable speed engine is cranked, the generator is configured to generate a first electrical power based at least partially on an operating speed of the variable speed engine, and wherein the PV power source is configured to generate a second electrical power and the energy storage device is configured to supply a third electrical power to the DC-link.

3. The power generation system of claim 2, wherein the PCC is configured to be coupled to at least one of a local electrical load and an electric grid, wherein the PCC is further configured to receive a grid power from the electric grid, and wherein the DFIG is configured to supply an alternating current (AC) power to the local electrical load based on one or more of the first electrical power, the second electrical power, and the third electric power supplied to the PCC.

4. The power generation system of claim 3, wherein, if the grid power is not available and an auxiliary power is less than a load requirement, the rotor side converter is configured to crank the variable speed engine and the line side converter is configured to control a frequency and a magnitude of a voltage at the PCC, wherein the auxiliary power comprises the second electrical power, the third electrical power, or a sum of the second electrical power and the third electrical power.

5. The power generation system of claim 3, wherein, if the grid power is not available and an auxiliary power is not greater than a load requirement by a threshold value, the rotor side converter is configured to crank the variable speed engine and the line side converter is configured to control a frequency and a magnitude of a voltage at the PCC, wherein the auxiliary power comprises the second electrical power, the third electrical power, or a sum of the second electrical power and the third electrical power.

6. The power generation system of claim 1, wherein, to aid in operating the generator as motor, the rotor side converter is configured to control at least one of a voltage or a current applied to the rotor winding.

7. The power generation system of claim 6, wherein the rotor side converter is configured to control at least one of a frequency and a magnitude of the voltage applied to the rotor winding to crank the variable speed engine.

8. The power generation system of claim 1, wherein the line side converter is configured to control a magnitude and a frequency of a voltage at the PCC until the variable speed engine is operated at a determined speed.

9. The power generation system of claim 8, wherein the rotor side converter is configured to control the magnitude and the frequency of the voltage at the PCC after the variable speed engine is operated at the determined speed.

10. The power generation system of claim 1, wherein, to aid in operating the generator as motor, the rotor side converter is configured to short the rotor winding.

11. The power generation system of claim 1, wherein a power rating of the rotor side converter is selected based on a maximum slip range or an instantaneous slip of the DFIG.

12. The power generation system of claim 1, wherein, to crank the variable speed engine, the generator is configured to produce a determined amount of torque based on one or more of a DC-link voltage, a rotor side current capacity, and a turn's ratio of a stator winding and a rotor winding.

13. The power generation system of claim 1, wherein the PV power source is coupled to the DC-link via a first DC-DC converter.

14. The power generation system of claim 1, wherein the energy storage device is coupled to the DC-link via a second DC-DC converter.

15. A method for cranking a variable speed engine mechanically coupled to a doubly-fed induction generator (DFIG), comprising:
supplying a direct current (DC) power to a DC-link of the DFIG, wherein the DFIG comprises a generator comprising a rotor winding disposed on a rotor and a stator winding disposed on a stator, a rotor side converter electrically coupled to the rotor winding, and a line side converter electrically coupled to the stator winding at a point of common coupling (PCC), wherein the rotor side converter and the line side converter are electrically coupled to each other via the DC-link; and
cranking the variable speed engine by operating the generator as motor via the rotor side converter.

16. The method of claim 15, wherein cranking the variable speed engine comprises controlling at least one of a voltage or a current applied to the rotor winding via the rotor side converter.

17. The method of claim 15, wherein cranking the variable speed engine comprises shorting the rotor winding via the rotor side converter.

18. The method of claim 15, further comprises generating a first electrical power by at the stator winding once the variable speed engine is cranked.

19. The method of claim 15, wherein supplying the DC power to the DC-link comprises supplying at least one of a second electric power from a photo-voltaic (PV) power source or a third electric power from an energy storage device.

20. The method of claim 19, further comprising determining if a grid power is not available and an auxiliary power is less than a load requirement, wherein the auxiliary power comprises the second electrical power, the third electrical power, or a sum of the second electrical power and the third electrical power, wherein the variable speed engine is cranked via the rotor side converter in response to determining that the grid power is not available and the auxiliary power is less than a load requirement.

21. The method of claim 19, further comprising determining if a grid power is not available and an auxiliary power is not greater than a load requirement by a threshold value, wherein the auxiliary power comprises the second electrical power, the third electrical power, or a sum of the second electrical power and the third electrical power, wherein the variable speed engine is cranked via the rotor side converter in response to determining that the grid power is not available and the auxiliary power is less than a load requirement.

22. The method of claim 15, further comprising controlling a frequency and a magnitude of a voltage at the PCC via the line side converter until the variable speed engine is operated at a determined speed.

23. The method of claim 22, further comprising controlling the frequency and the magnitude of the voltage at the PCC via the rotor side converter after the variable speed engine is operated at the determined speed.
